(19) United States
(12) Patent Application Publication
(10) Pub. No.: US 2019/0071302 A1
(43) Pub. Date: Mar. 7, 2019

(54) REIN SYSTEM

(71) Applicant: CORRECT CONNECT, LLC, Athens, GA (US)

(72) Inventors: ALLISA HUESTIS, ATHENS, GA (US); JILL HENNEBERG, ATHENS, GA (US)

(73) Assignee: CORRECT CONNECT, LLC, ATHENS, GA (US)

(21) Appl. No.: 15/693,474

(22) Filed: Sep. 1, 2017

(51) Int. Cl. B68B 5/06; B68B 1/04; A01K 15/02; A41D 19/00; G09B 19/00

(52) U.S. Cl. CPC B68B 5/06; B68B 1/04; A41D 2600/10; A41D 19/0034; G09B 19/00; A01K 15/02

(57) ABSTRACT

A rein system including a set of reins, in combination with at least one glove to be worn by a rider. The set of reins are attachable to a bit on a horse to thereby form a loop. The set of reins have a left side and a ride side, the left side have a first gripping section with a first portion and a second portion and the right side have a second gripping section with a third portion and a fourth portion. The glove has a mechanical fastener thereon such that when the glove is worn by the rider and the rider grasps one of the first gripping section or the second gripping section with the glove, the glove is mechanically fastened to the appropriate gripping section. The mechanical fastener of the glove is inset in the glove and flush or recessed with the surface of the glove.

### BACKGROUND

Elegant and sophisticated in appearance, horse riding is a rather complicated art form to master. Attaining good horsemanship is not only important to the competitive rider, it is also important to the casual rider for safety of the rider as well as comfort of the horse. The riding reins are a key element in horse control and thus in attaining good horsemanship. The reins of a rider act in somewhat similar fashion to the steering wheel of a vehicle in that the reins help guide and control the actions of the horse. Therefore, in mastering good horsemanship it is necessary to achieve mastery of the reins.

One aspect of proper rein control is proper hand placement upon the reins. The reins have two ends which are attachable to a bit in order to form a loop. Each side of the reins has a gripping section where the hands of the rider are to be placed. Placement of the hands within a particular portion of the gripping section is dependent on the maneuvers to be performed. For example, if the rider is performing dressage wherein tight maneuvers and sharp turns are to be performed, the rider wants to place her hands on the upper portion of the gripping section—relatively closer to the bit—in order to have a more firm control of the horse, while a rider that is galloping cross-country, wherein long straightaways and gradual turns are to be expected, places her hands on the lower portion of the gripping section—relatively farther from the bit—in order to allow the horse to have more freedom.

While proper hand placement on the reins is second nature to experienced riders, proper hand placement can prove quite tricky to the beginning rider. Although riders understand the proper desired location of their hands during riding, executing theory into fact is oftentimes quite difficult. A rider will start a riding session with proper hand placement, but after an executed difficult maneuver, or an unexpected occurrence, will allow her hands to slip, either upwardly or downwardly along the reins, away from the desired location, thus not maintaining consistent contact with the horse's mouth.

Devices have been proposed that assist in proper hand placement on the reins during a ride. Some such devices use a mechanical barrier between adjoining hand grip portions on the rein that help prevent the hands of the rider from slipping from one portion to another during a ride. Other such devices utilize a tactile signaling method whereby a rider is able to tactilely determine if her hands are on the appropriate section of the reins.

Such prior devices give a rider feedback about hand placement, and if hand placement is incorrect, allow the rider to correct the hand placement on the reins. However, the prior art devices fail to help the rider maintain a firm grasp of the appropriate portion of the reins during a ride in order to develop the proper rein feel and muscle memory.

Therefore, there exists a need in the art for a device that allows a rider to position her hands on the appropriate portion of the gripping section of the reins and to maintain her hands in position during tricky or otherwise high pressure maneuvers, as well as in wet or sweaty conditions or other adverse conditions. Such a device should be of relatively simple design and construction and should be easy to use.

### SUMMARY OF THE INVENTION

The present invention relates to horse riding rein system that trains a user in the proper placement and maintenance of the user's hands upon the reins while riding a horse.

The training rein system of the present invention addresses the aforementioned needs in the art. The training rein system allows a rider to position her hands on the appropriate portion of the gripping section of the reins and to maintain her hands thereat during tricky or otherwise high pressure maneuvers, as well as in wet or sweaty conditions or other adverse conditions.

The training rein system of example embodiments of the present invention may include a set of reins, in combination with a left glove and a right glove, each glove to be worn by a rider, the set of reins attachable to a bit on a horse to thereby form a loop, the set of reins having at least a left side and a ride side. In some embodiments of the present invention the left side of the reins has a left gripping section with a first portion and a second portion and the right side has a right gripping section with a third portion and a fourth portion. In such embodiments, the that the left glove has a first mechanical fastener thereon which is inset in the surface of the glove such that the first mechanical fastener is flush or recessed with the surface of the glove and the right glove also has a second mechanical fastener thereon which is inset in the surface of the glove such that the first mechanical fastener is flush or recessed with the surface of the glove.

In many embodiments of the present invention, when the left glove is worn on the left hand of the rider and the right glove is worn on the right hand of the rider and the rider grasps the left gripping section with the left hand, the left glove is mechanically fastened to the left gripping section, and when the rider grasps the right gripping section with the right glove, the right glove is mechanically fastened to the right gripping section.

In some embodiments of the present invention, a first divider can be positioned between the first portion and the second portion of the left gripping section while a second divider can be positioned between the third portion and the fourth portion of the right gripping section. In many embodiments of the present invention, the first divider may be implemented as a divider that is cooperative with the mechanical fastener of the right or left glove between the first portion and the second portion and the second divider can also be implemented as a divider that is cooperative with the mechanical fastener of the right or left glove. The first and second barriers reside between the portions of the reins that are mechanically interactive with the right and left glove. The first divider may be of a different color relative to the first portion and the second portion and the second divider may be of a different color relative to the third portion and the fourth portion.

In some embodiments, the first mechanical fastener may comprise a first portion of cooperating hook and loop material disposed on the left glove and a corresponding second portion of cooperating hook and loop material located on the left gripping portion of the reins and the second mechanical fastener may comprise a third portion of cooperating hook and loop material disposed on the right glove and a corresponding fourth portion of cooperating hook and loop material located on the right gripping portion. Alternately, the first mechanical fastener may comprise a first adhesive tape portion located in the palm portion of the left glove such that the first adhesive tape portion contacts the left gripping section whenever the rider grasps the left gripping section with the left glove and the second mechanical fastener may comprise a second adhesive tape portion located in a palm portion of the right glove such that the second adhesive tape portion contacts the right gripping section whenever the rider grasps the right gripping section with the right glove.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 sets forth a line drawing of an environmental view of the training rein system of example embodiments of the present invention being utilized by a horse rider.

FIG. 2 sets forth a line drawing illustrating a perspective view of a rein system according to example embodiments of the present invention.

FIG. 3 sets forth a line drawing illustrating is a perspective view of the gloves of the training rein system using an adhesive tape mechanical fastener according to example embodiments of the present invention.

FIG. 4 sets forth a line drawing illustrating a perspective view of a glove of an example training rein system according to embodiments of the present invention.

FIG. 5 sets forth a line drawing illustrating a perspective view of a glove of an example training rein system according to embodiments of the present invention.

FIG. 6 sets forth a line drawing illustrating a perspective view of a portion of a rein of a rein system according to example embodiments of the present invention,

FIG. 7. sets forth a line drawing illustrating a perspective view of a portion of a rein of a rein system according to example embodiments of the present invention,

Similar reference numerals refer to similar parts throughout the several views of the drawings.

### DETAILED DESCRIPTION

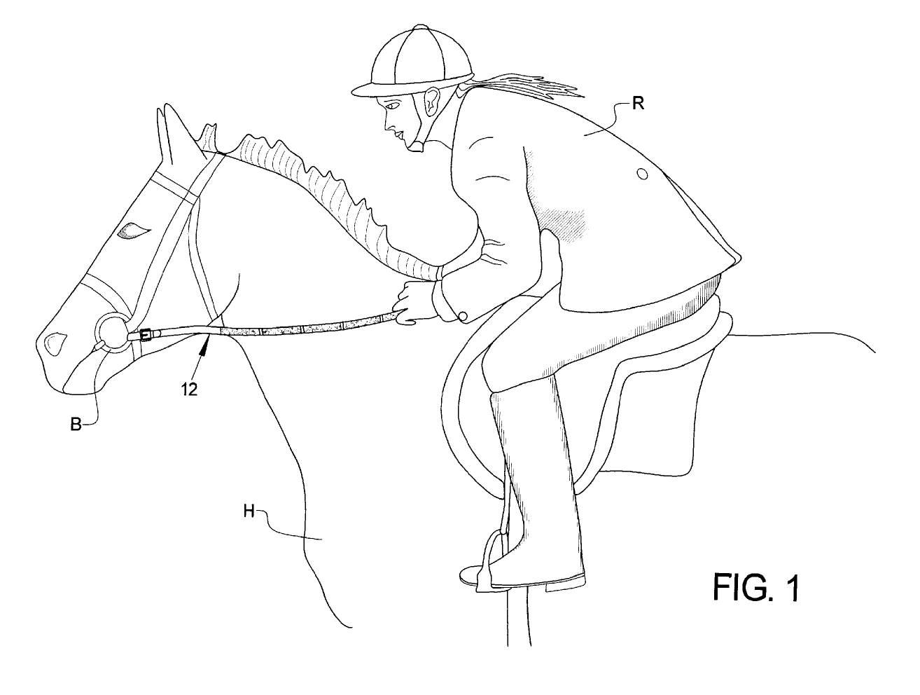

Methods, systems, reins, gloves and other aspects of the present invention are described with reference to the accompanying drawings, beginning with FIG. 1. FIG. 1 sets forth a line drawing of an environmental view of a rein system according to example embodiments of the present invention. FIG. 1 depicts a reins system according to embodiments of the present invention being utilized by a horse rider. The example of FIG. 1 includes a rein system 10 according to embodiments of the present invention. In the example of FIG. 1, the rein system 10 includes reins 12 that are attachable to a bit B on a horse H to thereby form a loop and the set of reins 12 are held in the example of FIG. 1 by a rider R.

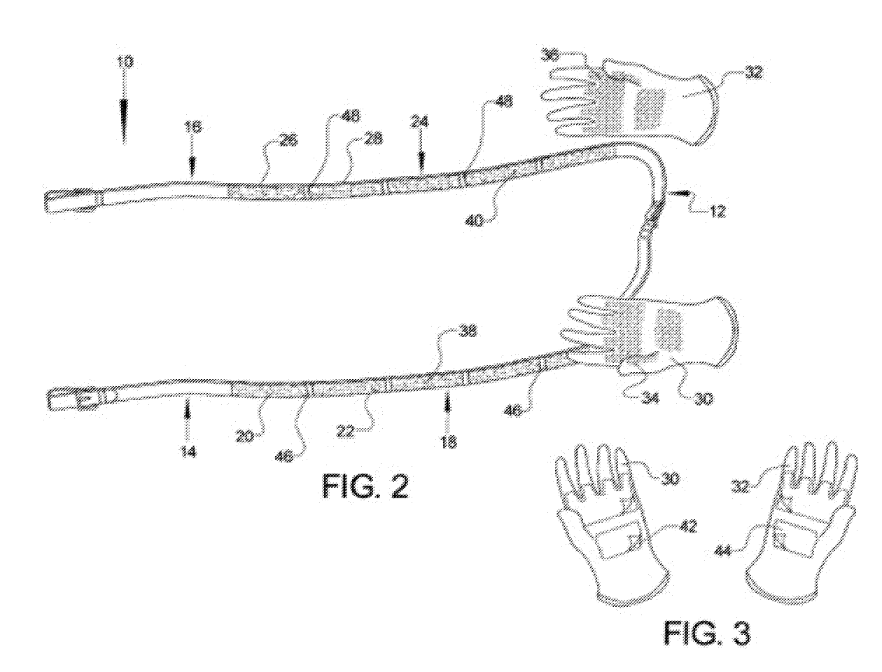

For further explanation, FIG. 2 sets forth a line drawing illustrating is a perspective view of a rein system according to example embodiments of the present invention. The rein system 10 of FIG. 2 has a left side 14 and a right side 16. The left side 14 has a left gripping section 18 with a first portion 20 and a second portion 22 and the right side 16 has a right gripping section 24 with a third portion 26 and a fourth portion 28. A left glove 30 is provided in the example of FIG. 2 and the glove 30 worn on the left hand of a rider R while a right glove 32 is provided and is worn on the right hand of the rider R. The left glove 30 has a first mechanical fastener 34 on its palm portion that is inset in the glove and flush or recessed with the surface of the left glove while the right glove 32 has a second mechanical fastener 36 on its palm portion that is inset in the glove and flush ore recessed with the surface of the right glove. The left glove 30 is worn on the left hand of the rider R and the right glove 32 is worn on the right hand of the rider R. When the rider R grasps the left gripping section 18 with the left hand, the left glove 30 is mechanically fastened to the left gripping section 18, and when the rider R grasps the right gripping section 24 with the right glove 32, the right glove 32 is mechanically fastened to the right gripping section 24.

In some embodiments of the present invention, the first mechanical fastener 34 may include a first portion of cooperating hook and loop material disposed on the left glove 30 and a corresponding second portion of cooperating hook and loop material 38 located on the left gripping portion 18 of the reins 12. A second mechanical fastener 36 may also comprise a hook and loop material disposed on the right glove 32 and a corresponding third and fourth portion of cooperating hook and loop material 40 may be located on the right gripping portion 24. As the rider R grasps the appropriate portion of the left gripping section 18 with her left glove 30, the first portion of hook and loop material cooperatively mates with the second portion of hook and loop material 38. Similarly, as the rider R grasps the appropriate portion of the right gripping section 24 with her right glove 32, the third portion of hook and loop material cooperatively mates with the fourth portion of hook and loop material 40. This helps maintain the rider's hands on the appropriate portion of each gripping section 18 and 24 even when the rider R is performing a difficult maneuver and turns her concentration to the maneuver and away from hand placement on the reins 12. The bonds of the hook and loop material are sufficiently strong to help hold the rider's hands on the reins 12 during most maneuvers yet not so strong such that if the rider R is thrown from the horse H, her hands break free from the reins 12 relatively easily.

For further explanation, FIG. 3 sets forth a line drawing illustrating is a perspective view of the gloves of the training rein system using an adhesive tape mechanical fastener according to example embodiments of the present invention. In some embodiments of the present invention, the first mechanical fastener 34 may comprise a first adhesive tape portion 42 located a palm portion of the left glove 30 such that the first adhesive tape portion 42 contacts the left gripping section 18 whenever the rider R grasps the left gripping section 18 with the left glove 30. Similarly, the second mechanical fastener 36 may comprise a second adhesive tape portion 44 located a palm portion of the right glove 32 such that the second adhesive tape portion 44 contacts the right gripping section 24 whenever the rider R grasps the right gripping section 24 with the right glove 32. The adhesive grip strength of the first adhesive tape portion 42 and the second adhesive tape portion 44 are each sufficiently strong to help hold the rider's hands on the reins 12 during most maneuvers yet not so strong such that if the rider R is thrown from the horse H, her hands break free from the reins 12 relatively easily. In addition, the rider is able to move hand position when desired. In the example of FIG. 3, the adhesive tape portions are inset in the glove such that the adhesive tape is flush or recessed with the surface of the glove.

Returning to FIG. 2, if desired, a first divider 46 can be positioned between the first portion 20 and the second portion 22 of the left gripping section 18 while a second divider 48 can be positioned between the third portion 26 and the fourth portion 28 of the right gripping section 24. The dividers 46 and 48 can be used as either a visual or tactile aid for the rider's proper hand placement. The first divider 46 may be implemented as a divider placed between the first portion 20 and the second portion 22 and the second divider 48 may be implemented as a divider placed between the third portion 26 and the fourth portion 28. In some embodiments, alternately or in addition, the first divider 46 may be of a different color relative to the first portion 20 and the second portion 22 and the second divider 48 may be of a different color relative to the third portion 26 and the fourth portion 28. The two dividers 46 and 48 in the example of FIG. 1 may also be raised portions with respect to the remainder of their respective gripping section 18 and 24), the rider R will tactilely sense each divider 46 and 48 when placing her hands on the reins 12, allowing her to properly place her hands on the appropriate portion of each gripping section 18 and 24 in addition to providing mechanical interaction at the barrier itself. However, since the dividers 46 and 48 are of a different color with respect to the remainder of their respective gripping section 18 and 24, the difference in the colors will help the rider R visually guide her hands to the appropriate portions of each gripping section in addition to providing mechanical interaction at the barrier itself.

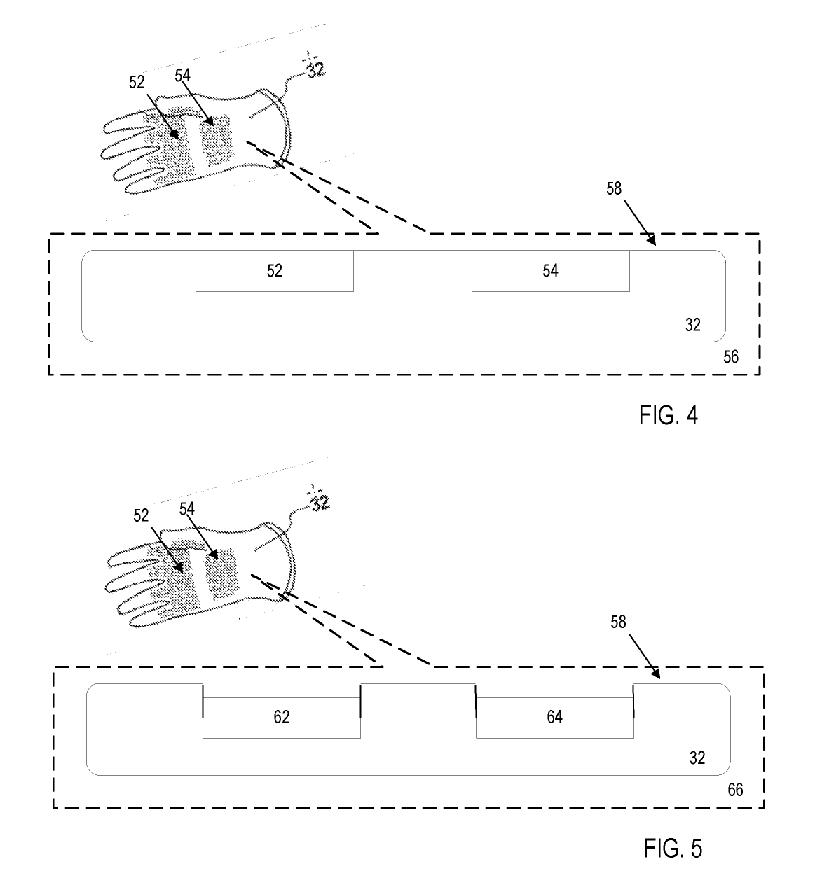

For further explanation, FIG. 4 sets forth a line drawing illustrating a perspective view of a glove of an example training rein system according to embodiments of the present invention. The glove 32 in the example of FIG. 4 includes mechanical fasteners 52 and 54 inset in the palm and finger portions of the glove. The callout 56 of FIG. 4, illustrates that the mechanical fasters 52 and 54 in this example are inset in the glove and flush with the surface 58 of the glove 32. Having the mechanical fasters 52 and 54 inset in the glove and flush with the surface 58 of the glove 32 advantageously allows the rider to more easily slip the reins providing substantially improved functionality of the training reigns.

For further explanation, FIG. 5 sets forth a line drawing illustrating a perspective view of a glove of an example training rein system according to embodiments of the present invention. The glove 32 in the example of FIG. 4 includes mechanical fasteners 62 and 64 inset in the palm and finger portions of the glove. The callout 66 of FIG. 5, illustrates that the mechanical fasters 62 and 64 in this example are inset in the glove and recessed with the surface 58 of the glove 32. Having the mechanical fasters 62 and 64 inset in the glove and recessed with respect to the surface 58 of the glove 32 advantageously allows the rider to more easily slip the reins providing substantially improved functionality of the training reigns.

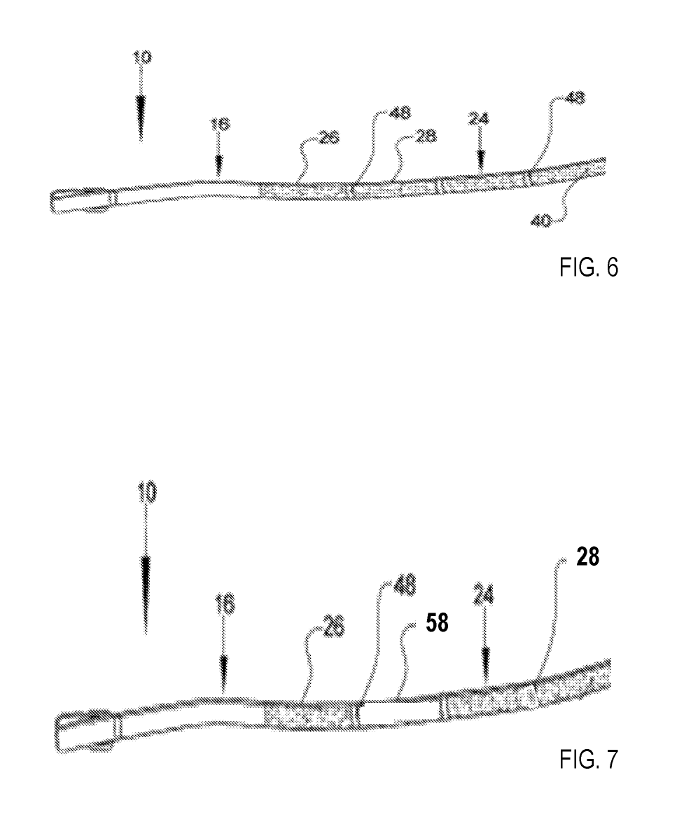

For further explanation, FIG. 6 sets forth a line drawing illustrating a perspective view of a portion of a rein of a rein system according to example embodiments of the present invention. The example of FIG. 6 includes a right side 16 of the reins of FIG. 2. The right side 16 in the example of FIG. 6 has a right gripping section 24 with a third portion 26 and a fourth portion 28. When the rider R grasps the right gripping section 24 with the right glove, the right glove is mechanically fastened to the right gripping section 24.

In some embodiments the divider 48 of FIG. 6 is implemented as a divider that is also cooperative with a glove of the training system of the present invention. The divider 48 of FIG. 6 may be implemented of cooperating hook and loop material advantageously allowing the rider's glove to cooperate with the barrier 48 and also allowing the divider to be moved along the reins. The divider 48 also can be used as either a visual or tactile sensor for further aiding the rider R in proper hand placement.

For further explanation, FIG. 7. sets forth a line drawing illustrating a perspective view of a portion of a rein of a rein system according to example embodiments of the present invention. In the example of FIG. 7, between the portions 26 and 28 of the gripping section 28 is a section 58 that is not interactive with the rider's glove. That is the section 58 is not cooperative with the faster of the rider's glove. The section 58 in the example of FIG. 7 may be implemented as a section of leather, a section of cloth, a section of plastic or a section any other material that will occur to those of skill in the art.

This disclosure describes the rein system of the present invention with reference to training from time-to-time. This is for explanation and not for limitation. While the rein system of the present invention is extremely useful as a training aid, very skilled riders benefit from the present invention. As such, rein systems according to embodiments of the present invention are useful to riders of all skills and all such systems and uses are well within the scope of the present invention.

While the invention has been particularly shown and described with reference to an embodiment thereof, it will be appreciated by those skilled in the art that various changes in form and detail may be made without departing from the spirit and scope of the invention.

What is claimed is:

1. A rein system including set of reins, in combination with at least one glove to be worn by a rider, the set of reins attachable to a bit on a horse to thereby form a loop, the set of reins having a left side and a ride side, the left side having a first gripping section with a first portion and a second portion and the right side having a second gripping section with a third portion and a fourth portion such that the at least one glove has a mechanical fastener thereon such that when the glove is worn by the rider and the rider grasps one of the first gripping section or the second gripping section with the glove, the glove is mechanically fastened to the appropriate gripping section; wherein the mechanical fastener of the at least one glove is inset in the glove and flush or recessed with the surface of the glove.

2. The rein system of claim 1 further comprising:
a first divider positioned between the first portion and the second portion of the first gripping section; and
a second divider positioned between the third portion and the fourth portion of the second gripping section.

3. The rein system of claim 2 wherein the first divider resides between the first portion and the second portion is mechanically cooperative with the mechanical fastener of the glove and forms and the second divider resides between the third portion and the fourth portion and is mechanically cooperative with the mechanical fastener of the glove.

4. The rein system of claim 2 wherein the first divider is of a different color relative to the first portion and the second portion and the second divider is of a different color relative to the third portion and the fourth portion.

5. The rein system of further comprising a first non-mechanically cooperative section residing between the first portion and the second portion and a second non-mechanically cooperative section residing between the third portion and the fourth portion

6. The rein system of claim 1 wherein the mechanical fastener comprises:
a first portion of cooperating hook and loop material disposed on the glove; and
a corresponding second portion of cooperating hook and loop material located on each of the first gripping portion and the second gripping portion.

7. The rein system of claim 1 wherein the mechanical fastener comprises an adhesive tape portion located on a palm portion of the glove such that the adhesive tape portion contacts the reins whenever the rider grasps the reins with the glove.

8. A set of reins, in combination with a left glove to be worn on a left hand of a rider and a right glove to be worn on a right hand of the rider, the set of reins attachable to a bit on a horse to thereby form a loop, the set of reins having a left side and a ride side, the left side having a left gripping section with a first portion and a second portion and the right side having a right gripping section with a third portion and a fourth portion such that the left glove has a first mechanical fastener thereon and the right glove has a second mechanical fastener thereon such that when the left glove is worn on the left hand of the rider and the right glove is worn on the right hand of the rider and the rider grasps the left gripping section with the left hand, the left glove is mechanically fastened to the left gripping section, and rider grasps the right gripping section with the right glove, the right glove is mechanically fastened to the right gripping section and wherein the mechanical fasters of the right and left gloves are inset in the gloves and are flush or recessed with the surface of the gloves.

9. The reins of claim 8 further comprising:
a first divider positioned between the first portion and the second portion of the left gripping section; and
a second divider positioned between the third portion and the fourth portion of the right gripping section.

10. The reins of claim 9 wherein the first divider resides between the first portion and the second portion is mechanically cooperative with the mechanical fastener of the glove and forms and the second divider resides between the third portion and the fourth portion and is mechanically cooperative with the mechanical fastener of the glove.

11. The reins of claim 9 wherein the first divider is of a different color relative to the first portion and the second portion and the second divider is of a different color relative to the third portion and the fourth portion.

12. The reins of claim 8 further comprising a first non-mechanically cooperative section residing between the first portion and the second portion and a second non-mechanically cooperative section residing between the third portion and the fourth portion

13. The reins of claim 8 wherein the first mechanical fastener comprises a first portion of cooperating hook and loop material disposed on the left glove and a corresponding second portion of cooperating hook and loop material located on the left gripping portion and the second mechanical fastener comprises a third portion of cooperating hook and loop material disposed on the right glove and a corresponding fourth portion of cooperating hook and loop material located on the right gripping portion.

14. The reins of claim 8 wherein the first mechanical fastener comprises a first adhesive tape portion located on a palm portion of the left glove such that the first adhesive tape portion contacts the left gripping section whenever the rider grasps the left gripping section with the left glove and the second mechanical fastener comprises a second adhesive tape portion located a palm portion of the right glove such that the second adhesive tape portion contacts the right gripping section whenever the rider grasps the right gripping section with the right glove.

15. A method for controlling and maneuvering a horse comprising the steps of:
providing a set of reins attachable to a bit on the horse to thereby form a loop, the set of reins having a left side and a ride side, the left side having a first gripping section with a left portion and a right portion and the right side having a second gripping section with a third portion and a fourth portion providing a left glove to be worn on the left hand of the rider such that the left glove has a first mechanical fastener thereon such that when the left glove is worn on the left hand of the rider and the rider grasps the left gripping section with the left hand the left glove is mechanically fastened to the left gripping section; and
providing a right glove to be worn on the right hand of the rider such that the right glove has a second mechanical fastener thereon such that when the right glove is worn on the right hand of the rider and the rider grasps the right gripping section with the right hand the right glove is mechanically fastened to the right gripping section; and wherein the mechanical fasters of the right and left gloves are inset in the gloves and are flush or recessed with the surface of the gloves.

16. The method of claim 15 further comprising the steps of:
providing a first divider positioned between the first portion and the second portion of the left gripping section; and
providing a second divider positioned between the third portion and the fourth portion of the right gripping section.

17. The method of claim 16 wherein the first divider resides between the first portion and the second portion is mechanically cooperative with the mechanical fastener of the glove and forms and the second divider resides between the third portion and the fourth portion and is mechanically cooperative with the mechanical fastener of the glove.

18. The method of claim 16 wherein the first divider is of a different color relative to the first portion and the second portion and the second divider is of a different color relative to the third portion and the fourth portion.

19. The method of claim 15 wherein the first mechanical fastener comprises a first portion of cooperating hook and loop material disposed on the left glove and a corresponding second portion of cooperating hook and loop material located on the left gripping portion and the second mechanical fastener comprises a third portion of cooperating hook and loop material disposed on the right glove and a corresponding fourth portion of cooperating hook and loop material located on the right gripping portion.

20. The method of claim 15 wherein the first mechanical fastener comprises a first adhesive tape portion located on a palm portion of the left glove such that the first adhesive tape portion contacts the left gripping section whenever the rider grasps the left gripping section with the left glove and the second mechanical fastener comprises a second adhesive tape portion located on a palm portion of the right glove such that the second adhesive tape portion contacts the right gripping section whenever the rider grasps the right gripping section with the right glove.
